(19) United States
(12) Patent Application Publication
(10) Pub. No.: US 2024/0414214 A1
(43) Pub. Date: Dec. 12, 2024

(54) SUPPORT PROVISION DEVICE, SYSTEM, AND PROGRAM

(71) Applicants: Yoshimitsu KAGIWADA, Ashigarakamigun Matsudamachi, Kanagawa (JP); KEYSOFT, INC., Ashigarakamigun Matsudamachi, Kanagawa (JP)

(72) Inventor: Yoshimitsu KAGIWADA, Ashigarakamigun Matsudamachi (JP)

(73) Assignees: Yoshimitsu KAGIWADA, Ashigarakamigun Matsudamachi, Kanagawa (JP); KEYSOFT, INC., Ashigarakamigun Matsudamachi, Kanagawa (JP)

(21) Appl. No.: 18/289,096

(22) PCT Filed: May 6, 2022
(86) PCT No.: PCT/JP2022/019593

§ 371 Date: Jun. 10, 2024

(30) Foreign Application Priority Data
May 3, 2021 (JP) 2021-078227

(51) Int. Cl. H04L 65/1089; H04L 65/403

(52) U.S. Cl. CPC H04L 65/1089; H04L 65/403

(57) ABSTRACT

A method according to one or more embodiment is disclosed that provides cheering using a system comprising a room memory that stores supporters belonging to a room. The method may include sharing an image or audio of the supporters among the supporters belonging to the same room stored in the room memory on each of supporters' devices, transmitting the image or audio of a room or a supporter selected from the room stored in the room memory to an external cheering receiving system, and transmitting the image or audio of the room or the supporter selected from the room stored in the room memory to an external cheering relay system.

### TECHNICAL FIELD

This invention relates to a method, system and program for providing cheering, and in particular, to a method of providing cheering, etc., whereby image and audio of the cheering audience are provided online to remote locations such as stadiums and broadcasting stations.

### BACKGROUND ART

The applicant of this application has obtained a patent for a viewer-participation type broadcast program delivery method (Patent Document 1). According to this patented invention, multiple viewers can deliver cheers and images to the stadium and other locations through communication.

However, in a large-scale event such as the Olympics, for example, there are many people who want to send their cheers and images, and it becomes difficult to expose everyone's cheering at the stadium and in broadcast programs. When considering a service that charges supporters to expose their cheers at stadiums or in broadcast programs, it is necessary to improve the probability of exposure as much as possible in order to promote charging, and it is also necessary to provide some benefit of charging to all supporters.

### PRIOR ART DOCUMENT

### Patent Documents

Patent document 1 U.S. Pat. No. 3,984,016

### SUMMARY OF INVENTION

### Problem to be Solved by the Invention

This invention is subject to the realization of a system that enhances the benefits to the cheering audience in a service that delivers the cheering audience's image and audio from remote locations.

### Means to Solve the Problem

To solve this problem, the present invention provides a method of providing cheering by a system equipped with a room memory that stores a plurality of supporters belonging to a room, etc., and has a step of having each supporter's device share each other's image or audio among a plurality of supporters belonging to the same room stored in this room memory. It also has a step of transmitting the image or audio of a room or a supporter selected from the rooms stored in the room memory to an external cheering receiving system. Furthermore, the system has a step of transmitting the image or audio of the room or the supporter selected from the rooms stored in the room memory to an external cheering relay system.

The other invention has a step wherein the cheering receiving system receives a first image or audio transmitted from one cheering service system that implements the above method of providing cheering. The other invention also includes a step wherein the cheering receiving system receives, via the cheering relay system, a second image or sound transmitted from another cheering service system that implements the above method of providing cheering. Further, the cheering receiving system includes the step of generating and outputting for a viewer an image or sound that is selected or mixed with the first image or sound and the second image or sound as necessary. Here, “mix” shall include a form in which multiple independent images are simultaneously played back on a single screen. It also includes the simultaneous playback of multiple independent sounds from different loudspeakers.

According to this, the image or audio of the cheers is exposed to each other in the room. In addition, the image or audio of some cheers may be exposed for viewers through the cheering receiving system or the cheering relay system.

### Effects of the Invention

Thus, the present invention can realize a system with enhanced benefits for supporters in a service that remotely delivers the image or audio of the supporters.

### BRIEF DESCRIPTION OF DRAWINGS

FIG. 1 is a diagram illustrating an overall configuration of the invention.

FIG. 2 is a configuration diagram illustrating a ticket sales unit illustrated in FIG. 1.

FIG. 3 is a configuration diagram illustrating an admission controller illustrated in FIG. 1.

FIG. 4 is a configuration diagram illustrating a merchandise sales department illustrated in FIG. 1.

FIG. 5 is a configuration diagram illustrating a community providing unit illustrated in FIG. 1.

FIG. 6 is a configuration diagram illustrating a switch illustrated in FIG. 1.

FIG. 7 is a configuration diagram illustrating a cheering output controller illustrated in FIG. 1.

FIG. 8 is a diagram illustrating an overall configuration of another embodiment.

FIG. 9 is a diagram illustrating a screen configuration of a variation of an embodiment of FIG. 8.

### EMBODIMENTS FOR CARRYING OUT THE INVENTION

### Overall Configuration

Embodiments of the invention are described based on the drawings. As an example, a model is considered that enables not only Japanese supporters but also overseas supporters to remotely support the Tokyo Olympics. In order to get supporters to charge, benefits should always be provided to the supporters. However, when trying to expose supporters remotely to competition venues and broadcast programs, etc., the number of supporters around the world is huge, and the probability of each supporter being exposed is low, making it difficult for all supporters to enjoy the benefit of being exposed. Therefore, this project aims to realize a means of how to increase the merits of a large number of supporters.

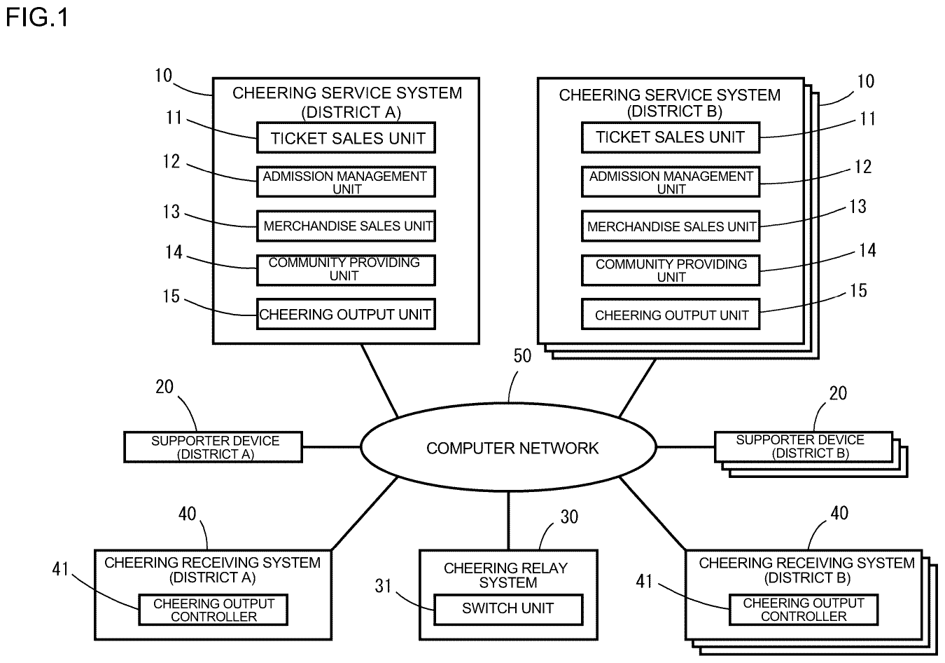

FIG. 1 is a diagram illustrating the overall configuration of this embodiment. In this embodiment, the cheering providing system has a plurality of cheering service systems 10, a plurality of supporter devices 20, a cheering relay system 30, a plurality of cheering receiving systems 40, and a computer network 50. The systems and devices 10 to 40 are computers and are operated by processors executing programs. Each system may include electronic circuitry other than computers necessary for operation.

The computer in each system and device 10 to 40 is equipped with a processor such as a central processing unit, main memory such as RAM, and auxiliary memory such as HDD. The computer is also equipped with an input device such as a keyboard, an output device such as a display, and a communication device such as a gateway. The supporter device 20 may be a portable terminal.

The following is an overview of the role of each system. Each memory in the description is provided within the storage area of a storage device.

### [Cheering Service System]

The cheering service system 10 performs selling tickets for supporters to use the cheering service and managing the admission of supporters who use the tickets to the cheering service. The cheering service system 10 also performs selling goods to the supporters who enter or access the cheering service system 10 and providing the cheering community to the supporters who enter. Furthermore, the cheering service system 10 performs outputting to the outside the image and audio of the cheering community generated by the cheering community.

### [Supporter Device]

The supporter device 20 is a device operated by a supporter and accesses the cheering service system 10 to purchase tickets, use tickets, enter the cheering service, purchase goods, and use the cheering community. The supporter device 20 also transmits the image and audio of the supporter to the cheering service system 10. The image and sound of the supporter may be the actual image and sound, or may be the image and sound of an avatar of said supporter.

### [Cheering Relay System]

The cheering relay system 30 receives the image and audio of each supporter from multiple cheering service systems 10, selects the image and audio corresponding to the request of each cheering receiving system 40 from among them, and provides them to the cheering receiving system 40.

### [Cheering Receiving System]

Each cheering receiving system 40 receives the image and audio of the cheering audience output from the cheering service system 10 and provides them to the public through TV broadcasts, online distribution, or output devices at the event venue, etc. In addition, the cheering receiving system 40 provides the image and audio of the cheering audience received from the cheering relay system 30 in response to a request to the cheering relay system 30 to the public through TV broadcasting, net distribution, or output devices at the event venue, etc., as necessary.

### [Computer Networks]

The computer network 50 enables each system and device 10 to 40 to communicate with each other via the Internet.

### [Details of Each Configuration]

The configuration of this form is described in further detail.

### [Cheering Service System]

The multiple cheering service systems 10 are divided into districts A and B.

Each cheering service system 10 has a ticket sales unit 11, an admission management unit 12, a merchandise sales unit 13, a community providing unit 14, and a cheering output unit 15. Each of the units 11 to 15 operates by a processor executing a program.

### [Districts A and B]

The districts A and B represent the geographical area of responsibility of each of the cheering service systems 10, regardless of how large or small the area of responsibility may be. In this implementation, the district A is Japan and the district B is a foreign country other than Japan, and the district B includes the United States, China, Australia, etc.

### [Ticket Sales Unit]

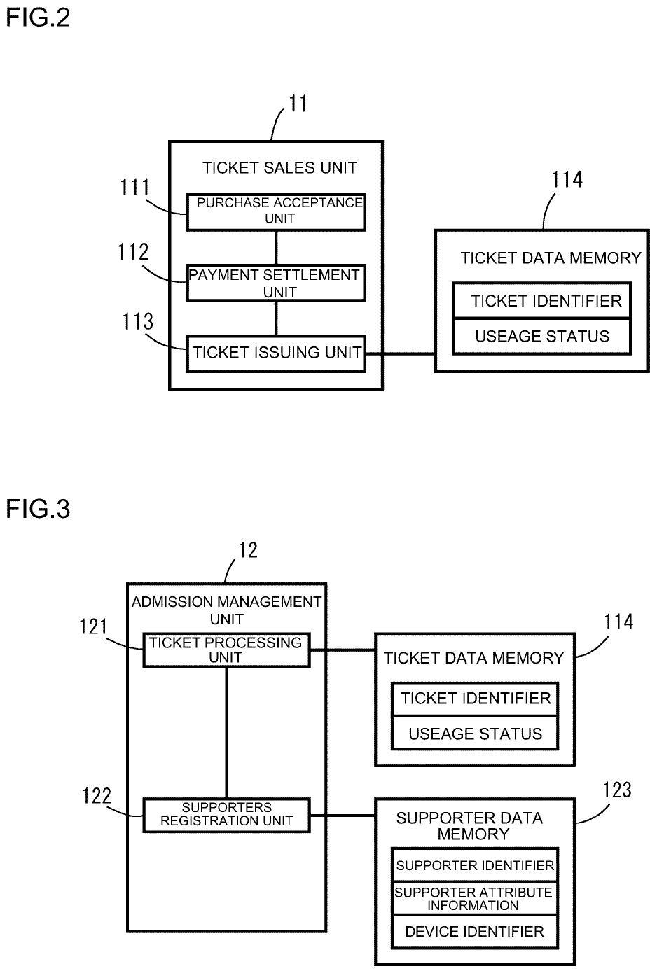

The configuration of the ticket sales unit 11 is shown in FIG. 2. The ticket sales unit 11 has a purchase acceptance unit 111, a payment settlement unit 112, and a ticket issuing unit 113. The ticket sales unit 11 accesses the ticket data memory 114. The operation of the ticket sales unit 11 is realized by a processor executing a predetermined program.

### [Purchase Acceptance Unit]

The purchase acceptance unit 111 receives a request from the supporter device 20 to purchase a ticket to use the cheering service, and requests the payment settlement unit 112 to process the payment of the ticket price.

### [Payment Settlement Unit]

When the payment settlement unit 112 receives a request for settlement processing from the purchase acceptance unit 111, it communicates with the supporter device 20 and an external settlement system (not shown) to execute the prescribed settlement of the ticket price. When the settlement is completed, it notifies the ticket issuing unit 113 to that effect.

### [Ticket Issuing Unit]

Upon receiving notification of the completion of payment from the payment settlement unit 112, the ticket issuing unit 113 issues a ticket that completed payment to the purchaser. A possible method of issuing tickets is to send a unique ticket identifier for each ticket to the program of the supporter device 20 from which the ticket was purchased. Alternatively, the ticket identifier could be sent to the e-mail address of the ticket purchaser.

### [Ticket Data Memory]

The ticket data memory 114 stores the ticket identifier of a ticket issued by the ticket issuing unit 113, linked to the ticket's state of use (unused or used). The initial value of the usage status is “unused”. The ticket identifier is a unique value for each ticket issued.

### [Admission Management Unit]

The structure of the admission management unit 12 is shown in FIG. 3.

The admission management unit 12 has a ticket processing unit 121 and a supporter registration unit 122. The admission management unit 12 accesses the ticket data memory 114 and the supporter data memory 123. The operation of admission management unit 12 is realized by a processor executing a predetermined program.

### [Ticket Processing Unit]

The ticket processing unit 121 receives a request for admission to the cheering service accompanied by a ticket identifier from the supporter device 20. It then determines whether the usage status associated with the received ticket identifier is “unused” or not, based on the record in the ticket data memory 114 described above. If the usage status associated with the ticket identifier is “unused”, the ticket processing unit 121 rewrites the usage status to “used”, permits the requesting supporter device 20 to enter the cheering service, and hands over the operation to the supporter registration unit 122. On the other hand, if the usage state associated with the ticket identifier is already “used”, a message to deny admission is returned to the requesting supporter device 20.

### [Supporter Registration Unit]

The supporter registration unit 122 accepts input of the identifier and attribute information of the supporter from the supporter device 20 whose admission to the cheering service is permitted in the ticket processing unit 121. The attribute information of a supporter includes, for example, the country to support, team or individual category, the age and gender of the supporter, and the country, city, town, village, or other region to which the supporter belongs. The identifier of the supporter can be an ID, password, or nickname, etc. The supporter registration unit 122 links the supporter identifier received from the supporter device 20 with the supporter attribute information and registers the information in the supporter data memory 123.

### [Supporter Data Memory]

As described above, the supporter data memory 123 stores the supporter identifier of each supporter in connection with the supporter attribute information.

The supporter identifier is a unique value for each supporter.

### [Merchandise Sales Unit]

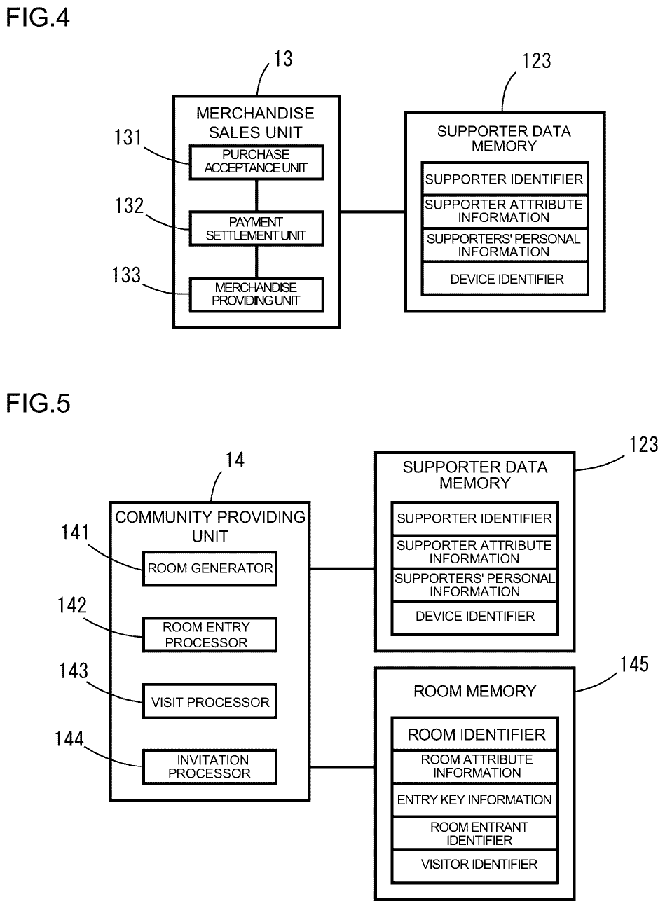

The configuration of the merchandise sales unit 13 is shown in FIG. 4. The merchandise sales unit 13 has a purchase acceptance unit 131, a payment settlement unit 132, and a merchandise providing unit 133. The merchandise sales unit 13 accesses the supporter data memory 123. The operation of the merchandise sales unit 13 is realized by a processor executing a predetermined program.

### [Purchase Acceptance Unit]

The purchase acceptance unit 131 accepts order requests for goods from the supporter device 20. The order request is appended with the supporter identifier, the goods identifier, and the quantity to be purchased, etc. The order request is also appended with personal information such as the delivery address. When the purchase acceptance unit 131 receives an order request for goods, it determines whether the supporter identifier added to the order request is registered in the supporter data memory 123. If the corresponding supporter identifier is not registered, the order may be rejected. On the other hand, if the corresponding supporter identifier is registered, the personal information added to the order request is linked to the corresponding supporter identifier and registered in the supporter data memory 123, and the payment for the ordered goods is requested to the payment settlement unit 132. The purchase acceptance unit 131 may treat the order request for the goods as valid regardless of whether the supporter identifier is registered in the supporter data memory 123 or not.

### [Payment Settlement Unit]

The payment settlement unit 132 prompts the purchaser's supporter device 20 to settle the payment for the ordered goods using the specified settlement method. When the payment settlement unit 132 confirms the completion of the payment settlement, it requests the merchandise providing unit 133 to process the delivery of the purchased goods.

### [Merchandise Providing Unit]

If the purchased goods are contents, programs or license codes that can be provided online, the merchandise providing unit 133 guides the purchaser's supporter device 20 on how to obtain the contents, programs or license codes. Alternatively, the information is addressed to the e-mail address of the supporter. When the purchased goods are to be shipped, the merchandise providing unit 133 automatically sends a shipping request to the external merchandise provider's device.

### [Supporter Data Memory]

As described above, in addition to the supporter identifier and supporter attribute information, the supporter data memory 123 may also store personal information of the supporter and others tied to the supporter identifier.

### [Community Providing Unit]

The structure of the community providing unit 14 is shown in FIG. 5. The community providing unit 14 has a room generator 141, a room entry processor 142, a visit processor 143, and an invitation processor 144. The community providing unit 14 accesses the supporter data memory 123 and the room memory 145. The operation of the community providing unit 14 is realized by a processor executing a predetermined program.

### [Room Generator]

The room generator 141 receives a room generation request from the supporter device 20. A room is a place where multiple supporters (supporter device 20) share their own image and audio in real time online. The room generation request is accompanied by the requester's supporter identifier, room attribute information, and entry key information. The room attribute information includes information on the country, team or individual to support, room introduction, room public/private settings, and whether the room can be visited. The room generator 141 determines that the supporter identifier of the room generation requestor is registered in the supporter data memory 123 and is not registered as a room entrant identifier or a visitor identifier in the room memory 145. If these conditions are met, the room generator 141 generates a unique room identifier for each room, ties this room identifier to the room attribute information and entry key information attached to the room generation request, and registers it in the room memory 145. It also ties the supporter identifier of the supporter who made the room generation request to the room identifier generated earlier as the room entrant identifier. The room generator 141 notifies the generated room identifier to the supporter device 20 that requested room generation.

Here, a supporter who generates a room can freely set the room attribute information of that room. For example, if the room attribute information of a generated room is set as a room to support a specific soccer team, multiple supporters can enter the room and support the specific soccer team. Similarly, if the room's attribute information is set to a specific region (it can be a prefecture or a municipality), multiple supporters who have ties to that specific region can enter the room and cheer for their local team. However, although the room is designed as a community of people with the same attributes, it can also be simply a room where people who want to support gather to form a room. For example, friends may simply gather to form a room and cheer together.

### [Room Entry Processor]

The room entry processor 142 accepts a request to obtain a room list from the supporter device 20. The supporter identifier of the requester is added to the room list acquisition request. If the added supporter identifier is not registered in the supporter data memory 123, the room entry processor 142 rejects the request. On the other hand, if the added supporter identifier is registered in the supporter data memory 123, a room list is generated and sent to the requesting supporter device 20. The room list is generated by enumerating the room identifier and room attribute information for each room among the rooms registered in the room memory 145, targeting rooms that are not set as private in the room attribute information.

The room entry processor 142 accepts a request from the supporter device 20 to enter the room selected from the room list. The request is appended with the requester's supporter identifier. The room entry processor 142 determines that the added supporter identifier is registered in the supporter data memory 123 and is not registered in the room entrant identifier in the room memory 145. If these conditions are not met, the room entry is denied. On the other hand, if the condition is satisfied, the owner of the room is requested to approve the entry to the selected room. Specifically, the supporter identifier and supporter attribute information of the supporter who wishes to enter the room are sent to the supporter device 20 of the supporter who is the owner of the room, and approval is requested. If the room owner approves the entry, the room entry processor 142 registers the supporter identifier of the supporter who requested to enter the room as the room entrant identifier, linking it to the corresponding room identifier. The condition for room entry may be that the supporter who requested entry entered the correct entry key information from the supporter device 20. On the other hand, the approval of the room owner may not be required to enter a room. In this case, for each room to be generated, the room attribute information may include whether the owner's approval is required to enter the room.

### [Visit Processing Unit]

The visit processor 143 accepts a tour request for the room selected from the room list from the supporter device 20. The tour request is appended with the requestor's supporter identifier. Alternatively, the supporter identifier at the time of requesting the room list is used as the supporter identifier of the person requesting the tour. The visit processor 143 determines that the attribute information of the room requested for the tour is available for visiting, the supporter identifier of the tour requestor is registered in the supporter data memory 123, and the supporter identifier is not registered as an entrant identifier in the room memory 145. If these conditions are met, the owner of the selected room is requested to approve the visit. Specifically, the supporter identifier and supporter attribute information of the supporter who wishes to visit the room are sent to the supporter device 20 who is the owner of the room, and approval is requested. If the room owner approves the tour, the visit processor 143 registers the supporter identifier of the supporter who requested the tour in the room memory 145, linking the supporter identifier of the supporter to the corresponding room identifier as a visitor identifier. On the other hand, the approval of the room owner may not be required for the tour. In this case, for each room to be generated, the room attribute information may include whether approval is required for the tour.

### [Invitation Processing Unit]

The invitation processor 144 lets supporters who are invited to enter the room (called invitees) by the room owner, etc., enter the room. The room owner provides the room identifier and corresponding entry key information to the invitee in advance. The inviter requesting entry to the room sends entry key information corresponding to the room identifier, and his/her own supporter identifier from the supporter device 20. The invitation processor 144 receives entry key information corresponding to the room identifier, and the supporter identifier transmitted from the supporter device 20. It then determines that the combination of the received room identifier and the entry key information is registered in the room memory 145, and that the supporter identifier is registered in the cheering supporter data memory 123, and that the supporter identifier is not registered in the room memory 145 as a room entrant identifier. If these conditions are met, the owner of the corresponding room is requested to approve the invitee's entry. Specifically, the supporter identifier of the supporter who wishes to enter the room as an invitee is sent to the supporter device 20 of the supporter who is the owner of the room, and approval is requested. If the room owner approves the entry, the invitation processor 144 registers the supporter identifier of the supporter who requested entry into the room in the room memory 145 with the corresponding room identifier as a room entrant identifier. On the other hand, the approval of the room owner may not be required for the invitee to enter the room. In this case, for each room to be generated, the room attribute information may include whether the room owner's approval is required for the invitee to enter the room. Here, the entry key information may be simply the address of the room.

### [Room Memory]

The room memory 145, as described above, stores the room identifier, room attribute information, entry key information, room entrant identifier, and visitor identifier tied to each room. Among the room entrant identifiers, the owner of the room is stored associated with a flag indicating that he/she is the owner of the room. The room identifier has a unique value for each room to be generated.

### [Cheering Output Unit]

Returning to FIG. 1, the cheering output unit 15 of the cheering service system 10 receives the real-time image and audio of each supporter from each supporter device 20. Then, the real-time image and audio of each entrant in the room are distributed live to each supporter device 20 so that the real-time image and audio of each entrant is shared among multiple entrants in each room. This allows the room occupants to get excited by cheering for a specific event by watching the same TV program among each other, etc., and exposes each supporters to each other in the room. A program to realize such operation may be created by applying an existing web conferencing system program.

In addition, the cheering output unit 15 distributes live real-time image and audio of the entrants in the corresponding room to the supporter devices 20 of the supporters whose visitor identifiers are registered in the room memory 145. This may allow visitors to check the atmosphere of the room before deciding to enter. Here, the visitor may be restricted to only image or audio. The audio and image of the visitor may be disabled for the supporters in the room. The image or audio of the supporters in the room may be set to disable image or audio individually for the visitors. These setting functions may also be created by applying existing web conferencing system programs.

The cheering output unit 15 also distributes live real-time image and audio of one or more entrants in the room selected from the rooms that are open to the public to the cheering relay system 30 and the cheering receiving system 40. The distributed image and audio are received and used by the cheering relay system 30 and the cheering receiving system 40. The image and audio in the room may be selected, for example, by the cheering output unit 15 automatically controlling the channels of the image switcher. The selection method may include selecting a room whose room attribute information matches a predetermined value specified in advance, or selecting a room whose room identifier matches a value randomly generated at regular intervals.

Room attribute information (information on cheering countries, teams or individuals, room introduction, etc.) of the corresponding room is added to the real-time image and audio to be transmitted.

### [Supporter Device]

Next, the supporter devices 20 are described. As shown in FIG. 1, there are multiple supporter devices 20, which are divided into the districts A and B. The supporter device 20 is a computer equipped with a camera, microphone, and speaker or earphone jack, and may be a portable device such as a smartphone or a tablet terminal. Although only one supporter device 20 is shown in each ward, there are actually multiple devices in each ward.

### [Districts A and B]

The districts A and B indicate the geographical locations of the supporter devices 20. In this implementation, the district A is Japan, and the district B is a foreign country other than Japan, and the district B includes the United States, China, Australia, etc. The supporter devices 20 in the district A use the cheering service system 10 in the district A and cannot use the cheering service system 10 in the district B in principle. In addition, multiple supporter devices 20 in district B can also, in principle, use only the cheering service system 10 whose respective locations coincide with the area of responsibility of the cheering service system 10. For example, the supporter device 20 located in Japan in the district A uses the cheering service system 10 whose area of responsibility is Japan. The supporter device 20 located in the U.S., which is in district B, uses the cheering service system 10 that is in charge of the U.S. Similarly, the supporter device 20 located in China uses the cheering service system 10 with China as its area of responsibility, and the supporter device 20 located in Australia uses the cheering service system 10 with Australia as its area of responsibility.

However, a supporter device 20 not located in the district A may be considered as a supporter device 20 located in the district A and allowed to use the cheering service system 10 in district A. The same applies to district B. For example, an American in Japan may join the U.S. cheering service system 10 to support the U.S. side.

The location of the hardware of the cheering service system 10 in charge of each district is not limited to each district in which it is in charge. For example, the hardware of a cheering service system 10 with the United States as its area of responsibility may be installed in another country. In addition, multiple cheering service systems 10 responsible for different district may coexist on a single piece of hardware, as long as there are no problems with data traffic or processing load.

The cheering service system 10 may inspect the global IP addresses of the accessing supporter devices 20 and allow communication only to the supporter devices 20 with global IP addresses within its area of responsibility. This may allow even a large number of supporters to be distributed to the cheering service system 10 in district A, district B, and each district.

### [Cheering Relay System]

The configuration of the cheering relay system 30 is described below. The cheering relay system 30 receives the real-time image and audio of the cheering audience distributed live from each cheering service system 10, and transmits the real-time image and audio allocated for each cheering receiving system 40 to each cheering receiving system 40 from among them. The switch 31 performs that allocation. The cheering relay system 30 manages each real-time image and audio (called source) received from each cheering service system 10 by linking an input identifier and source attribute information. The input identifier is a unique identifier for each source and corresponds to the channel of the source. Source attribute information is room attribute information attached to each source. The linking of input identifiers and source attribute information is stored in the cheering source memory 314.

### [Switch]

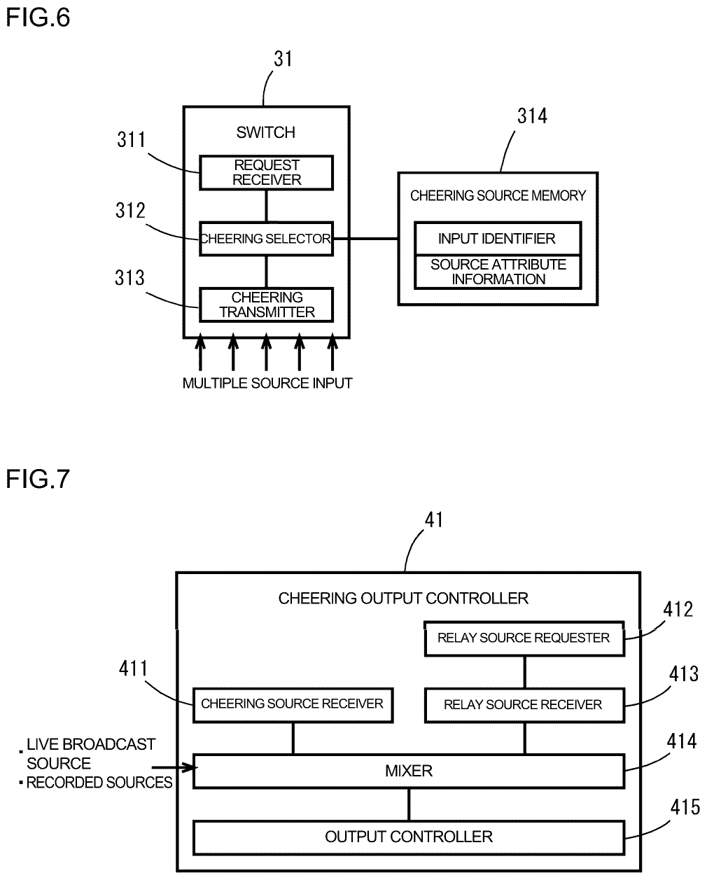

The configuration of switch 31 is shown in FIG. 6. The switch 31 includes a request receiver 311, a cheering selector 312, and a cheering transmitter 312. The switch 31 accesses the cheering source memory 314. The operation of the switch 31 is realized by a processor executing a predetermined program.

### [Request Receiver]

The request receiver 311 receives a transmission request for real-time image and audio from the cheering receiving system 40 and hands it over to the cheering selector 312. The transmission request is accompanied by a specification of source attribute information. The specification of source attribute information is, for example, the designation of the country, team or individual to be cheered, free words for searching room introductions, etc.

### [Cheering Selector]

The cheering selector 312 refers to the cheering source memory 314, obtains the input identifier corresponding to the specified source attribute information, and hands it over to the cheering transmitter 313.

### [Cheering Transmitter]

The cheering transmitter 313 streams live the source corresponding to the input identifier received from the cheering selector 312 to the requesting cheering receiving system 40. The cheering transmitter 313 may include an image switcher or image mixer for streaming as part of its configuration. This may allow the cheering sources delivered from each cheering service system 10 to be selectively delivered to the cheering receiving system 40.

### [Cheering Source Memory]

The Cheering source memory 314, as described above, stores an input identifier tied to source attribute information for each source received from the cheering service system 10. The input identifier has a unique value for each source received.

### [Cheering Receiving System]

Returning to FIG. 1, the configuration of the cheering receiving system 40 is described. The cheering receiving system 40 directly receives the cheering sources that are live-delivered by the cheering service system 10 in the same districts A and B. Apart from this, the cheering receiving system 40 can also receive sources of other district that are live-delivered from the cheering relay system 30. The source of the cheering audience in the same district is then output for viewers at the event site, TV broadcast or online distribution, depending on the use. If necessary, the sources of the supporters of other district are also selectively or mixed and output for viewers according to the event venue, TV broadcast or online distribution, etc. The cheering receiving system 40 is equipped with a cheering output controller 41 to realize said operation.

### [Districts A and B]

The districts A and B indicate the geographical locations of the cheering receiving systems 40. In this system, district A is Japan and district B is a foreign country other than Japan, and district B includes the U.S., China, Australia, etc. The cheering receiving system 40 in district A directly receives sources from the cheering service system 10 in district A. The multiple cheering receiving systems 40 in district B also, in principle, directly receive sources from the cheering service system 10 whose respective locations coincide with the area of responsibility of the cheering service system 10. For example, the cheering receiving system 40 located in Japan, which is in district A, directly receives sources from the cheering service system 10 in district A, which has Japan as its area of responsibility. Also, the cheering receiving system 40 located in the U.S., which is in district B, directly receives a source from the cheering service system 10 in district B, which is in charge of the U.S. Similarly, the cheering receiving system 40 located in China directly receives a source from the cheering service system 10 that has China as its area of responsibility, and the cheering receiving system 40 located in Australia directly receives a source from the cheering service system 10 that has Australia as its area of responsibility.

### [Cheering Output Controller]

The configuration of the cheering output controller 41 is shown in FIG. 7. The cheering output controller 41 has a cheering source receiver 411, a relay source receiver 412, a relay source receiver 413, a mixer 414, and an output controller 415. The operation of the cheering output controller 41 is realized by a processor executing a predetermined program.

### [Cheering Source Receiver]

The cheering source receiver 411 receives the source of the supporters directly from the cheering service system 10 in the same district.

### [Relay Source Requester]

The relay source requester 412 requests the cheering relay system 30 to send the source of the supporters in another district. The request is accompanied by the specification of source attribute information (e.g., designation of the country, team or individual to be cheered, free words for searching room introductions, etc.). The specification of source attribute information may be made via a keyboard or other input device.

### [Relay Source Receiver]

The relay source receiver 413 receives sources transmitted from the cheering relay system 30 addressed to the cheering receiving system 40.

### [Mixer]

The mixer 414 generates content for the venue, broadcast programs, or online distribution content, etc., which is a visual or auditory mix of the sources of supporters in the same district received by the cheering source receiver 411 and the sources of supporters in another district received by the relay source receiver 413. Alternatively, the mixer 414 generates content for the venue, broadcast program or online distribution content, etc., including visual and audio selected from the sources of the supporters of the same district received by the cheering source receiver 411 and the sources of the supporters of the other district received by the relay source receiver 413. The mixer 414 may mix the above-mentioned cheering sources as necessary in addition to recordings and live broadcasts for programs received separately from outside. The mix may be controlled via a keyboard or other input device. The mix may also be processed by an image switcher or other device.

### [Output Controller]

The output controller 415 outputs the above venue content, broadcast programs or online distribution content for viewers by means of a system (live distribution system, broadcasting system, etc.) prepared according to the program delivery method.

When output controller 415 outputs content for the venue, if there are multiple output devices (display monitors, speakers, etc.) at the venue, the image and audio to be output from each output device may be controlled for each output device.

The embodiment described above has the following effects. That is, instead of broadcasting the images and sounds of the world's cheering audience to the Tokyo Olympics stadiums all at once, for example, cheering by American is once sent to the U.S. cheering service system 10 (which may be located at a TV station), so that as many Americans as possible are exposed in the U.S. programs. Similarly, a Chinese person may be on the Chinese program. Some or all image or audio may be gathered in Japan, but in Japan, which is putting together the Tokyo Olympics, the U.S. may be shown, China may be shown, Australia may be shown, and so on, in order to see some of the cheering.

If all the cheering image or audio from around the world were to be sent to the stadium in Japan and shown on Japanese TV programs, only a few people would be exposed out of the huge number of people around the world. If this is done in each country, the chance of exposure for each supporter may increase.

When considering the business of cheering services, there is the question of whether the supporters still pay the fee even if they do not know if their cheering may reach the stadium, etc., and exposure is not guaranteed. Therefore, when we thought about exposing the images and sounds of all the supporters in some way, we came up with the idea of exposing the supporters to each other.

According to the present invention, as mentioned above, for example, you can cheer for a particular soccer team with your friends, and in this case, the friends in the room are always exposed to each other. The attributes of the room may also be gathered by a specific region (prefecture, city, town, village, etc.), as mentioned above. The cheering image and audio in the room may further reach the stadium, etc., which may promote the participation of supporters in the cheering service. However, the image and audio of each supporter (participant) may be actual image and audio, or avatars may be used.

The present invention is not limited to the above embodiments. The scope of the invention is the scope of the claims. The term “room” means a range of cheering supporters with whom image images, etc. are shared. A “supporter” is a person who is capable of sending images or sounds of cheering, and is not limited to a person who actually sends images or sounds of cheering.

Even if the cheering service system described with FIGS. 1 through 5 is not connected to the cheering receiving system or the cheering relay system, like-minded supporters can enjoy exposing each other in a room. The cheering service system alone is a valuable invention. In this case, “cheering” may be broadly read as “participation” because there is value in enjoying mutual exposure and information exchange, not limited to cheering. The cheering service system may also be used not only for sports, but also for music concerts, comedy shows, etc.

### [How to Send Cheering Messages, Etc.]

In the above embodiment, the supporter device 20 is configured to input the image and sound of the supporter. On the other hand, the cheering text, etc. may be input to the supporter device. An embodiment in which cheering text, etc. is input is described below.

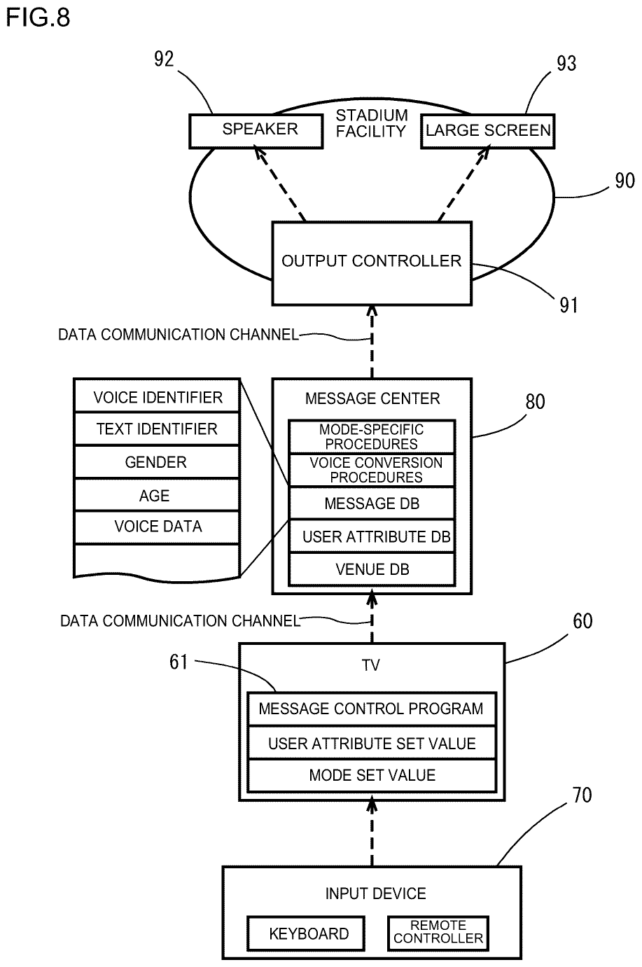

The cheering providing system shown in FIG. 8 includes a TV 60 and input device 70 as supporter devices, a message center 80 as a cheering service system, and a stadium facility 90 as a cheering receiving system. A stadium is an example, and this system can be applied to entertainment venues in general. Although only one TV 60 and stadium facility 90 communicating with the message center 80 are shown in the figure, there are, in fact, many of each.

### [TV]

The TV 60 is equipped with the general elements of a TV, such as an antenna terminal for receiving broadcast signals, a display device such as an LED display, an input interface such as infrared, and a communication device such as a NIC (see figure below). The TV also supports linked data broadcasting, so that pressing the d button on the remote control as the input device 70 activates the data broadcasting linked to the program being viewed. The TV 60 is equipped with a memory 61 for the message control program, user attribute set values and mode set values. The processor (not shown) of the TV 60 executes the message control program to realize various TV 60 operations described below. Here, TV 60 and input device 70 are given as specific examples as supporter devices, but they are not limited to this. For example, TV 60 may be replaced with a network terminal such as a personal computer or smartphone that receives and outputs Internet distribution of sports programs and other content. The input device 70 may be replaced with an input device equipped on said network terminal. In this case, an application program for the cheering service system installed in the network terminal may perform the necessary processing. In this way, a single network terminal may perform both viewing of contents and transmission of cheering. Here, in a configuration where the content audio is output from the speaker of the network terminal and the cheering audio is input from the microphone of the network terminal, it is recommended that the audio be viewed through earphones or other means to prevent feedback. The content distributor can also provide the service of content distribution and the service of the message center 80 in the same server or system in an integrated manner.

Here is a brief overview of the operation of the entire cheering providing system, including the TV 60. In mode 1, the cheer text input to the TV 60 is converted into speech and output audibly to the stadium of the program being viewed on the TV 60.

In mode 2, the cheering text selected by the selection operation input to the TV 60 is converted to speech and output audibly to the stadium of the program being viewed on the TV 60.

In mode 3, the cheering text entered into the TV 60 is displayed in text on the stadium of the program being viewed on the TV 60.

In mode 4, the cheering text selected by the selection operation entered into the TV 60 is displayed in text on the stadium of the program being viewed on the TV 60.

In mode 5, the cheering sound selected by the selection operation input to the TV 60 is output as audio to the stadium of the program being viewed on the TV 60.

### [Message Control Program]

The message control program is written in a language compatible with data broadcasting, such as BML (Broadcast Markup Language), and is supplied by data broadcasting when the d button is pressed. The message control program causes the processor of the TV 60 to perform the operation selected from the following according to the mode setting value.
In mode 1, the program accepts input of cheering text and transmission operation from the input device 70, adds the mode setting value, the identifier of the program being watched, and the user attribute setting value to the input cheering text using tags, etc., and transmits it to the message center 80 through data communication channels such as the Internet.
In mode 2, a choice of cheering text is displayed on the display device, and a cheering text selection operation is accepted from the input device 70. Next, when the transmission operation of the cheering text is accepted from the input device 70, the mode setting value, the identifier of the program being watched, and the user attribute setting value are added to the selected text identifier for cheering (cheering text identifier) using tags or other means. The message is then sent to the message center 80 through a data communication channel such as the Internet.
In mode 3, the program accepts input of cheering text and transmission operation from the input device 70, adds the mode setting value and the program identifier of the program being watched to the input cheering text using tags, etc., and transmits the text to the message center 80 through data communication channels such as the Internet.
In mode 4, a choice of cheering text is displayed on the display device, and the operation to select the cheering text is accepted from the input device 70. When the transmission operation of the cheering text is accepted from the input device 70, the mode setting value and the identifier of the program being watched are added to the selected cheering text using tags, etc., and the text is transmitted to the message center 80 through data communication channels such as the Internet.
In mode 5, a choice of cheering voice is displayed on the display device, and the operation to select the cheering voice is accepted from the input device 70. Next, when the transmission operation of the cheering voice is accepted from the input device 70, the mode setting value, the program identifier currently being viewed, and the user attribute setting value are added to the selected voice identifier for cheering (cheering voice identifier) using tags or other means. Then, it transmits the message to the message center 80 through a data communication channel such as the Internet.

### [User Attribute Set Value]

The user attribute set values indicate the gender and age of the user. The processor of the TV 60 accepts input of the user attribute set values from the input device 70 and stores them in the memory 61.

### [Mode Set Value]

The mode set value indicates the identifier of the above mode. The processor of the TV 60 accepts input of the mode setting value from the input device 70 and stores it in the memory 61.

### [Input Device]

The input device 70 is a device for inputting text and numerical values to the TV 60 and includes, for example, a keyboard and a remote control. Any method of transmitting information from the input device 70 to the TV 60 may be used, for example, a wired connection such as USB or a wireless connection such as infrared or Bluetooth (registered trademark).

### [Message Center]

Message center 80 is equipped with a network communication device such as a NIC (not shown) and communicates with TV 60 and stadium facilities 90 via data communication channel such as the Internet. Message center 80 is equipped with a storage device such as HDD and stores mode-specific procedures, voice conversion procedures, message database (DB), user attribute DB, and venue DB. The message center 80 is equipped with a processor such as a CPU and realizes various operations by reading and executing programs such as mode-specific procedures.

### [Mode-Specific Procedures]

The mode-specific procedures describe the processing steps by the processor for each mode setting value received from the TV 60. The procedure for each mode is as follows.
In mode 1, the voice conversion procedure is loaded to convert the cheering text received from TV 60 into cheering voice. At this time, a known voice synthesizer is applied according to the user attribute setting values (gender and age) added to the cheering text to convert voice data with voice tones according to the user attributes. The communication address of the stadium facility 90 corresponding to the program identifier received from TV 60 is obtained by referring to the venue DB, and the generated voice data is sent to the corresponding stadium facility 90 through data communication channels such as the Internet.
In mode 2, the message DB is referenced and the voice data corresponding to the cheering text identifier and user attribute setting value received from TV 60 is read from the message DB. Then, the communication address of the stadium facility 90 corresponding to the program identifier received from TV 60 is obtained by referring to the venue DB, and the read-out voice data is transmitted to the corresponding stadium facility 90 through a data communication channel such as the Internet.
In mode 3 and mode 4, the communication address of the stadium facility 90 corresponding to the program identifier received from TV 60 is obtained by referring to the venue DB, and the cheering text received from TV 60 is sent to the corresponding stadium facility 90 through the Internet or other data communication channel.
In mode 5, the message DB is referenced and the voice data corresponding to the cheering voice identifier and user attribute setting value received from TV 60 is read from the message DB. Then, the communication address of the stadium facility 90 corresponding to the program identifier received from TV 60 is obtained by referring to the venue DB, and the read-out voice data is transmitted to the corresponding stadium facility 90 through a data communication channel such as the Internet.

### [Voice Conversion Procedures]

The speech conversion procedure is a known program for having text converted to speech by a processor. The processor converts text to voice by executing the voice conversion procedure. At this time, the processor has the ability to execute a known voice synthesizer that adjusts the tone of the voice according to user attribute setting values (gender and age).

### [Message DB]

The message DB stores voice data that produce a variety of cheering voices. Each voice data is associated with a corresponding user attribute setting value (gender and age), cheering text identifier, and cheering voice identifier.

### [User Attribute DB]

When the message center 80 manages user attribute set values, the message center 80 may be equipped with a user attribute DB. The user attribute DB links and stores user identifiers and user attribute set values (gender and age). The user identifier may be a B-CAS card number or the like. One possible method of registering in the user attribute DB is to transmit the user identifier and the user attribute setting values from TV 60 to the message center 80 based on the operation of the input device 70, and to register this information in the user attribute DB. When using the user attribute DB, instead of receiving the user attribute set values from TV 60, the user identifier is received from TV 60, and the user attribute set values tied to the user identifier are read from the user attribute DB and used in the above process.

### [Venue DB]

The venue DB is registered for each program, linking the program identifier to the communication address of the stadium facility 90. The registration is done in advance by the persons involved in the program or in the message center 80.

### [Stadium Facilities]

The stadium facility 90 is equipped with a output controller 91 for messages, a speaker 92 that outputs the message audio, and a large screen 93 that displays the message text.

### [Output Controller]

The output controller 91 is equipped with a processor such as a CPU, a storage device such as an HDD, and a communication device such as a NIC as elements of a general computer. The output controller 91 receives voice data or text data of cheering from the message center 80 through a data communication channel such as the Internet. When the output controller 91 receives voice data of cheering, it causes the received voice data to be output from the speaker 92. On the other hand, when text data of cheering is received, the received text data is displayed on the large screen 93 or converted into voice and output from the speaker 92.

### [Speaker]

The speaker 92 may be any device that is located within the stadium and that loudens sound of audio. The speaker 92 may or may not be fixed within the playing field. No matter who is the owner of the speaker 92.

### [Large Screen]

The large screen 93 should be a display device that may be seen by many people at the same time.

### [Overall Operation]

The supporter operates the input device 70 and inputs the cheering text, cheering text selection operation or cheering voice selection operation to the TV 60 according to the preset mode.

TV 60 adds additional information (user attribute setting value, mode setting value or/and program identifier) to the cheering text, cheering text identifier or cheering voice identifier according to the operation of the input device 70 and the preset mode, and sends it to the message center 80.

The message center 80 transmits the corresponding cheering voice data or cheer text data to the corresponding stadium facility 90 based on the cheering text, cheering text identifier or cheer voice identifier received from the TV 60 and the additional information.

In the stadium facility 90, the output controller 91 causes audio based on the cheering voice data or text (character) data received from the message center 80 to be pronounced from the speaker 92. Alternatively, the text (characters) based on the cheering text data received from the message center 80 is displayed on the large screen 93.

[The Effect of this Form]

According to the above embodiment, a viewer of a program on TV 60 may have the cheering voice and cheering text output to the stadium where the competition is viewed and held by performing simple operations such as inputting cheering text and selecting cheering voice by pressing the d button on a remote control or other device.

Here, the functions of TV 60 described above may be installed in a set-top box (STB) or external tuner connected to the TV instead of the TV. In addition, instead of the voice conversion procedure performed by the message center 80, it is conceivable that the TV 60 performs the voice conversion procedure before sending the voice data to the message center 80. The user attribute settings (gender and age) for voice conversion and voice data selection need not necessarily be the true gender and age of the user.

### [Variations]

In the above embodiment, a TV 60 and its input device 70 are used as the cheering device. However, a computer device such as a smart phone or personal computer may be used instead of these devices.

Computer equipment is equipped with a processor such as a CPU, a memory such as memory cards, communication devices such as NICs, input devices such as touch panels, and display devices (not shown). The computer equipment realizes the following operations when the processor executes an installed application or a web application (cheering application). A smartphone may be used as an example.

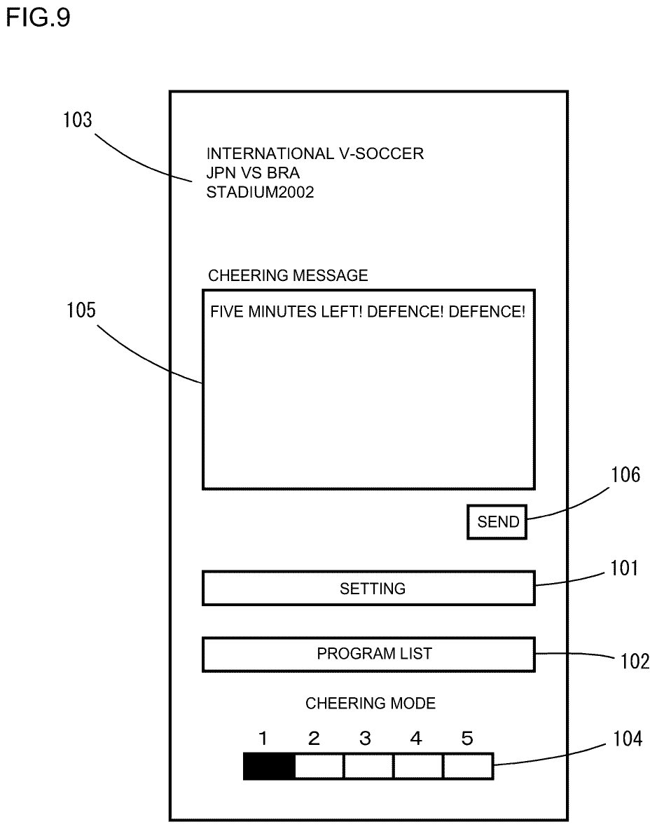

When the processor runs the cheering application, the screen shown in FIG. 9 is displayed on the touch panel. The user presses the setting button 101 to input user attributes such as gender and age. The processor stores the entered user attribute setting values in the memory device.

When the user presses the program list button 102, the processor downloads the program list from the Internet via a communication device (Wi-Fi or mobile network) and displays the list on the touch panel. The programs are not limited to TV broadcast programs, but may also be radio broadcast programs or Internet-distributed programs. The same smartphone may or may not be used to view TV broadcasts or radio broadcasts. The user selects a program such as a competition he/she wants to cheer for from the displayed program list. The selection is made by touching the touch panel. The processor displays such as the program name 103 of the selected program on the screen and stores the program identifier of the selected program in the memory device. The program identifier is included in the program list data and is pre-assigned to each program. In addition, the program list includes, for each program, the identifier of the target (team or player) that may be cheered (cheering target identifier) in advance. The user can select the target he/she wishes to cheer for from the list of possible targets by pressing the setting button 101. When a target is selected, the processor stores the cheerable identifier of the selected target in the memory device as part of the user attribute setting values.

The user also presses the mode button 104 to select one or five cheering modes. The processor lights the indicator for the selected cheering mode and stores the mode setting values for the selected cheering mode in the memory device. Here, the outline of the operation of each mode is the same as in the above embodiment.

When mode 1 or 3 is selected, the processor displays text box 105 on the touch panel to enable text input. The user enters a cheering message in text box 105 using flick input, etc., and then touches the send button 106. When the processor detects the touch on the send button 106, it adds the mode setting value, user attribute setting value, and program identifier stored in the memory device to the text message entered in the text box 105, and transmits it to the message center 80.

If mode 2, 4 or 5 is selected, the processor displays candidate cheering messages on the touch panel. The user selects a cheering message from among those displayed and touches the send button 106. When the processor detects the touch to the send button 106, it adds the mode setting value, user attribute setting value, and program identifier stored in the memory device to the cheering text identifier, text message, or cheering voice identifier, depending on the mode, as in the above embodiment. Then, the message is transmitted to the message center 80.

The operation of the message center 80 that receives the above information from the smartphone is the same as in the above embodiment, but the handling of the cheering target identifier included in the user attribute setting value is supplemented. The processor of the message center 80 adds the corresponding cheering target identifier when sending voice data or text data to the stadium facility 90. Based on the cheer target identifier received from the message center 80, the output controller 91 of the stadium facility 90 may select a speaker 92 to output the corresponding voice from a plurality of speakers in the stadium. Based on the cheer target identifier, the position and timing of displaying the corresponding text on the large screen 93 may be controlled.

As described above, the cheering providing system may be used by users operating computer equipment, not just TV.

### [Removal of Banned Terms]

When the processor of message center 80 receives an original text message from a TV or computer device as a supporter device, it determines whether the text contains prohibited broadcast terms. If the text is found to contain a broadcast-prohibited term, the text may be removed before audio conversion or text output. The part of the prohibited terms may be silenced in the audio. In this case, the text of the broadcast-prohibited term may be stored in the memory device in advance, and the processor may make a judgment by contrasting the text message with the broadcast-prohibited term stored in the memory device. This may allow a message excluding the broadcast-prohibited terms to be delivered to the stadium, etc.

### [Voice Conversion in Stadium Facilities 90]

The output controller 91 may be equipped with a function to convert the cheering text data received from the message center 80 into voice data. By providing the output controller 91 with the configuration necessary for the voice conversion procedure of the message center 80 described above, voice conversion at the stadium facility 90 is also possible.

### [How to Decide Who to Cheer]

When issuing tickets, the aforementioned ticket issuing unit 113 may generate and issue a unique ticket identifier for each event having a unique time and a unique location. In this case, the venue DB of the message center 80 is registered for each event, linking the ticket identifier to the communication address of the stadium facility 90. The registration is done in advance by the persons involved in the event or in the message center 80. In addition, the ticket issuing unit 113 delivers the URL, etc. associated with the ticket identifier by e-mail or other means to the user who has applied for support of the event to the supporter device.

Then, by accessing the above URL, etc. from the cheering device, the cheering application interface as shown in FIG. 9 is opened on the cheering device. In this case, the processor executing the cheering application ties the ticket identifier to a text message, etc., instead of the program identifier described above, and sends it to the message center 80.

The message center 80 reads the communication address of the stadium facility 90 corresponding to the received ticket identifier from the venue DB and sends a text message, etc. to the corresponding stadium facility 90.

In this case, the cheering application does not require the operation of selecting a program from the program list, and the cheering may be delivered to the venue of said specific event based on the tickets purchased for the specific event.

### [Converting Messages to Images]

The processor of message center 80 may convert the text message, cheering text identifier or cheer voice identifier received from the cheering device into an associated image with the text or voice. The image data of the converted image is transmitted from the message center 80 to the stadium facility 90. The output controller 91 of the stadium facility 90 displays the image on the large screen 93 based on the image data received from the message center 80.

In this case, the message center 80 has an image DB (not shown in the figure) in its memory in advance. In the image DB, the text, cheering text identifier or cheering voice identifier, and image data are linked and registered in advance. The registration is performed in advance by persons involved in the event or in the message center 80.

In this way, the visual effect of the cheering displayed on the large screen 93 may be enhanced. This conversion function to images may be provided in the stadium facility 90 instead of the message center 80.

### INDEX TO THE REFERENCE NUMERALS

10 Cheering service system
11 Ticket sales unit
12 Admission management unit
13 Merchandise sales unit
14 Community providing unit
15 Cheering output unit
20 Supporter device
30 Cheering relay system
31 Switch
40 Cheering receiving system
41 Cheering output controller
50 Computer network
60 TV
70 Input device
80 Message center
90 Stadium facility
91 Output controller
92 Speaker
93 Large screen
101 Setting button
102 Program list button
103 Program name, etc.
104 Mode button
105 Text box
106 Submit button
111 Purchase acceptance unit
112 Payment settlement unit
113 Ticket issuing unit
114 Ticket data memory
121 Ticket processing unit
122 Supporter registration unit
123 Supporter data memory
131 Purchase acceptance unit
132 Payment settlement unit
133 Merchandise providing unit
141 Room generator
142 Room entry processor
143 Visit processor
144 Invitation processor
145 Room memory
311 Request receiver
312 Cheering selector
313 Cheering transmitter
314 Cheering source memory
411 Cheering source receiver
412 Relay source requester
413 Relay source receiver
414 Mixer
415 Output controller

1. A method of providing cheering using a system comprising a room memory that stores supporters belonging to a room, the method comprising:
sharing an image or audio of the supporters among the supporters belonging to the same room stored in the room memory on each of supporters' devices;
transmitting the image or audio of a room or a supporter selected from the room stored in the room memory to an external cheering receiving system; and,
transmitting the image or audio of the room or the supporter selected from the room stored in the room memory to an external cheering relay system.

2. A method of providing cheering, comprising:
receiving by a cheering receiving system, a first image or audio transmitted from a first cheering service system that implements the method of providing cheering according to claim 1;
receiving by the cheering receiving system via a cheering relay system, a second image or audio transmitted from a second cheering service system that implements the method of providing cheering according to claim 1; and
generating and outputting to viewers an image that is a mix of the first image or audio and the second image or audio.

3. The method of providing cheering according to claim 2,
the cheering relay system receives the image or audio from the cheering service systems, and transmits an image or audio that is selected based on a request from a cheering receiving system to the cheering receiving system from which the request is made.

4. The method of providing cheering according to claim 1, wherein the image or audio is an image or audio of an avatar.

5. A system of providing cheering comprising a room memory that stores a plurality of supporters belonging to a room, the system comprising:
a communication providing unit that shares each other's image or audio among a plurality of supporters belonging to the same room stored in the room memory on each supporter's device;
a cheering output unit that transmits the image or audio of a room or supporter selected from the rooms stored in the room memory to an external cheering receiving system; wherein
the cheering output unit transmits the image or audio of a room or a supporter selected from the rooms stored in the room memory to an external cheering relay system.

6. A non-transitory computer-readable storage medium storing a program that provides cheering for a system including a room memory that stores a plurality of supporters belonging to a room, the program, which when read and executed, causes a computer to perform operations comprising:
sharing each other's image or audio among a plurality of supporters belonging to the same room stored in the room memory on each of supporters' devices;
transmitting the image or audio of selected room or supporter from the rooms stored in the room memory to an external cheering receiving system; and
transmitting the image or audio of selected room or supporter from the rooms stored in the room memory to an external cheering relay system.

7. The method of providing cheering according to claim 2, wherein the image or audio is an image or audio of an avatar.

8. The method of providing cheering according to claim 3, wherein the image or audio is an image or audio of an avatar.
